(19) United States
(12) Patent Application Publication
(10) Pub. No.: US 2009/0219552 A1
(43) Pub. Date: Sep. 3, 2009

(54) Apparatus for carrying a printing medium, printer that has the apparatus, method for carrying a printing medium and printer

(75) Inventor: Hitoshi Igarashi, Suwa-Shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/316,148

(22) Filed: Dec. 9, 2008

(30) Foreign Application Priority Data
Dec. 10, 2007 (JP) 2007-318757
Nov. 20, 2008 (JP) 2008-296385

(51) Int. Cl. G06K 15/10; H04N 1/60

(52) U.S. Cl. 358/1.5; 358/1.9

(57) ABSTRACT

The present invention relates to an apparatus for carrying a printing medium that transports the printing medium to a target position with high precision, a printer that has the device, a method for carrying a printing medium to a target position with high precision, and a printer.

As one embodiment to which the present invention is applied, an apparatus for carrying a printing medium includes: (A) a transport roller that transports the printing medium, (B) a motor for rotating the transport roller, (C) a detector that detects a transport amount of the printing medium transported by rotation of the transport roller, and (D) a controller that has a first control mode, in which a control of the motor is not performed on the basis of a detection result of the detector, and a second control mode, in which a control of the motor is performed on the basis of the detection result of the detector, and that uses the first control mode in a state where the printing medium stops and uses the second control mode after the printing medium starts to move.

### CROSS REFERENCES TO RELATED APPLICATIONS

This application claims priorities from Japanese Patent Application No. 2007-318757 filed on Dec. 10, 2007 and Japanese Patent Application No. 2008-296385 filed on Nov. 20, 2008, and the applications are incorporated in this application.

### BACKGROUND OF THE INVENTION

1. Field of the Invention

The present invention relates to an apparatus for carrying a printing medium, a printer that has the apparatus, a method for carrying a printing medium, and a printer.

2. Description of Related Applications

There is a printing apparatus that forms an image by discharging liquid droplets while transporting the paper. In such a printing apparatus, it is necessary to transport the paper to the desired position precisely in order to raise the quality of an image. Accordingly, the paper is precisely transported by fixing a rotary encoder or the like to a transport roller for transporting the paper and calculating the transport amount of the paper on the basis of an output of the encoder. For example, Japanese Unexamined Patent Publication No. 2001-251878 discloses performing a PID control on the basis of information from an encoder in transport of a printing medium.

However, since slip and the like may occur between the transport roller and the paper, the amount of transport by the transport roller that was detected by the rotary encoder does not necessarily match the actual transport amount of the paper. Therefore, there was a case where a printing medium could not be transported to the target position with high precision.

### SUMMARY OF THE INVENTION

The present invention has been made in order to solve at least some of the above-described problems and may be realized as the following embodiments or application examples.

As one embodiment to which the present invention is applied, an apparatus for carrying a printing medium includes: (A) a transport roller that transports the printing medium, (B) a motor for rotating the transport roller, (C) a detector that detects a transport amount of the printing medium transported by rotation of the transport roller, and (D) a controller that has a first control mode, in which a control of the motor is not performed on the basis of a detection result of the detector, and a second control mode, in which a control of the motor is performed on the basis of the detection result of the detector, and that uses the first control mode in a state where the printing medium stops and uses the second control mode after the printing medium starts to move.

Other features and objects of the present invention will be apparent by reading description of this specification referring to the accompanying drawings.

### BRIEF DESCRIPTION OF THE DRAWINGS

FIG. 1 is a block diagram of the entire configuration of a printer 1.

FIG. 2A is a schematic view of the entire configuration of the printer 1, and FIG. 2B is a cross-sectional view of the entire configuration of the printer 1.

FIG. 3 is a view for explaining an encoder 52 for a transport roller.

FIG. 4 is a view illustrating the configuration of a first detection unit 526 of the encoder 52 for a transport roller.

FIG. 5A is a timing chart showing output waveforms at the time of normal rotation of the encoder 52 for a transport roller, and FIG. 5B is a timing chart showing output waveforms at the time of reverse rotation of the encoder 52 for a transport roller.

FIG. 6 is a view for explaining an encoder 54 for direct detection.

FIG. 7 is a view for explaining the relationship of a controller 60, a transport unit 20, and each encoder in a first embodiment.

FIG. 8 is a view for explaining the speed profile.

FIG. 9 is a view for explaining speed reference and position reference.

FIG. 10 is a flow chart of a transport control in the first embodiment.

FIG. 11 is a view for explaining a controller 60′ in a second embodiment.

FIG. 12A is a graph of a temporal change of a duty signal, and FIG. 12B is a graph of a speed change of a transport motor.

FIG. 13 is a flow chart of a transport control in the second embodiment.

### DETAILED DESCRIPTION OF PREFERRED MODES

At least the following things will be apparent by description of this specification and description of the accompanying drawings.

### BEST MODE FOR CARRYING OUT THE INVENTION

At least the following matters will be apparent by description of this specification and accompanying drawings. An apparatus for carrying a printing medium including: (A) a transport roller that transports the printing medium, (B) a motor for rotating the transport roller, (C) a detector that detects a transport amount of the printing medium transported by rotation of the transport roller, and (D) a controller that has a first control mode, in which a control of the motor is not performed on the basis of a detection result of the detector, and a second control mode, in which a control of the motor is performed on the basis of the detection result of the detector, and that uses the first control mode in a state where the printing medium stops and uses the second control mode after the printing medium starts to move.

In this way, since the detection result of the detector is not used immediately after start of transport of the printing medium, transport of the printing medium can be stably started. In addition, since the printing medium is transported by using the detection result of the detector after the printing medium starts to move surely, the printing medium can be transported to the target position with high precision.

In the apparatus for carrying a printing medium, it is preferable that a first encoder for detecting a rotation amount of the transport roller be further included and the controller control the motor on the basis of a detection result of the first encoder in the first control mode. In addition, it is preferable that the controller control the motor in the second control mode after the transport amount of the printing medium is calculated on the basis of the detection result of the detector and the transport amount exceeds a predetermined amount. In addition, it is preferable that in the first control mode, the controller control the motor by increasing the electric power, which is supplied to the motor, by a predetermined amount for every predetermined time. In addition, it is preferable that the detector be a second encoder that detects a rotation amount of a roller that is driven to rotate with transport of the printing medium.

In this way, since the detection result of the detector is not used immediately after start of transport of the printing medium, transport of the printing medium can be stably started. In addition, since the printing medium is transported by using the detection result of the detector after the printing medium starts to move surely, the printing medium can be transported to the target position with high precision.

A method for carrying a printing medium including: a step of controlling a motor, which rotates a transport roller that transports the printing medium, on the basis of a rotation amount of the transport roller, until the rotation amount of the transport roller reaches a predetermined amount from a state where the printing medium stops; and a step of controlling the motor on the basis of a rotation amount of a roller, which is driven to rotate with transport of the printing medium, after the rotation amount of the transport roller exceeds the predetermined amount.

In this way, since the detection result of the detector is not used immediately after start of transport of the printing medium, transport of the printing medium can be stably started. In addition, since the printing medium is transported by using the detection result of the detector after the printing medium starts to move surely, the printing medium can be transported to the target position with high precision.

A program for operating an apparatus for carrying a printing medium that causes the apparatus for carrying a printing medium to perform: a step of controlling a motor, which rotates a transport roller that transports the printing medium, on the basis of a rotation amount of the transport roller, until the rotation amount of the transport roller reaches a predetermined amount from a state where the printing medium stops; and a step of controlling the motor on the basis of a rotation amount of a roller, which is driven to rotate with transport of the printing medium, after the rotation amount of the transport roller exceeds the predetermined amount.

In this way, since the detection result of the detector is not used immediately after start of transport of the printing medium, transport of the printing medium can be stably started. In addition, since the printing medium is transported by using the detection result of the detector after the printing medium starts to move surely, the printing medium can be transported to the target position with high precision.

A printer characterized in that (A) a motor that rotates a first roller that transports a printing medium, (B) a first detection unit that detects a rotation amount of a first rotating circular plate that rotates with rotation of the first roller, (C) a second roller that rotates with transport of the printing medium, (D) a second detection unit that detects a rotation amount of a second rotating circular plate that rotates with rotation of the second roller, and (E) a controller that controls the motor are included and the controller controls the motor using a first control mode, in which a control of the motor is performed on the basis of a detection result of the first detection unit, and a second control mode, in which a control of the motor is performed on the basis of a detection result of the second detection unit.

In this way, since the controller can use the first and second control modes properly, transport of the printing medium can be performed more stably compared with a case where a motor is controlled in a single control mode on the basis of an output of a single detection unit (encoder).

Furthermore, in the printer, it is preferable that the controller control the motor in the second control mode when the rotation amount of the second rotating circular plate detected by the second detection unit exceeds a predetermined amount after controlling the motor in the first control mode and control the motor only in the first control mode when the second detection unit does not detect the rotation amount of the second rotating circular plate.

In this way, also in the case where the second detection unit did not detect the rotation amount of the second rotating circular plate even though the printing medium is transported, the controller can control the motor on the basis of the first control mode. Also in the case where the second detection unit did not detect the rotation amount of the second rotating circular plate, it can be prevented that the controller cannot control the motor.

Hereinafter, preferred embodiments of the present invention will be described with reference to the accompanying drawings. In addition, embodiments described below are described as examples of the present invention, and all configurations described are not essential components of the present invention.

### PREFERRED EMBODIMENTS

Hereinafter, embodiments will be described on the basis of the drawings.

### First Embodiment

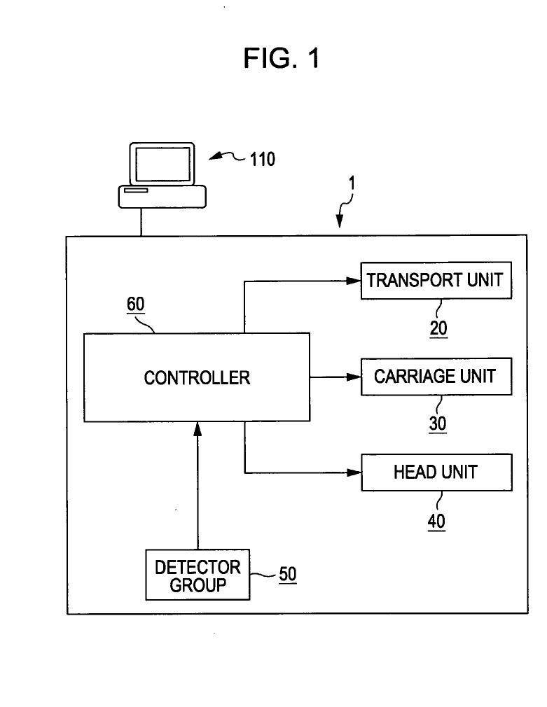

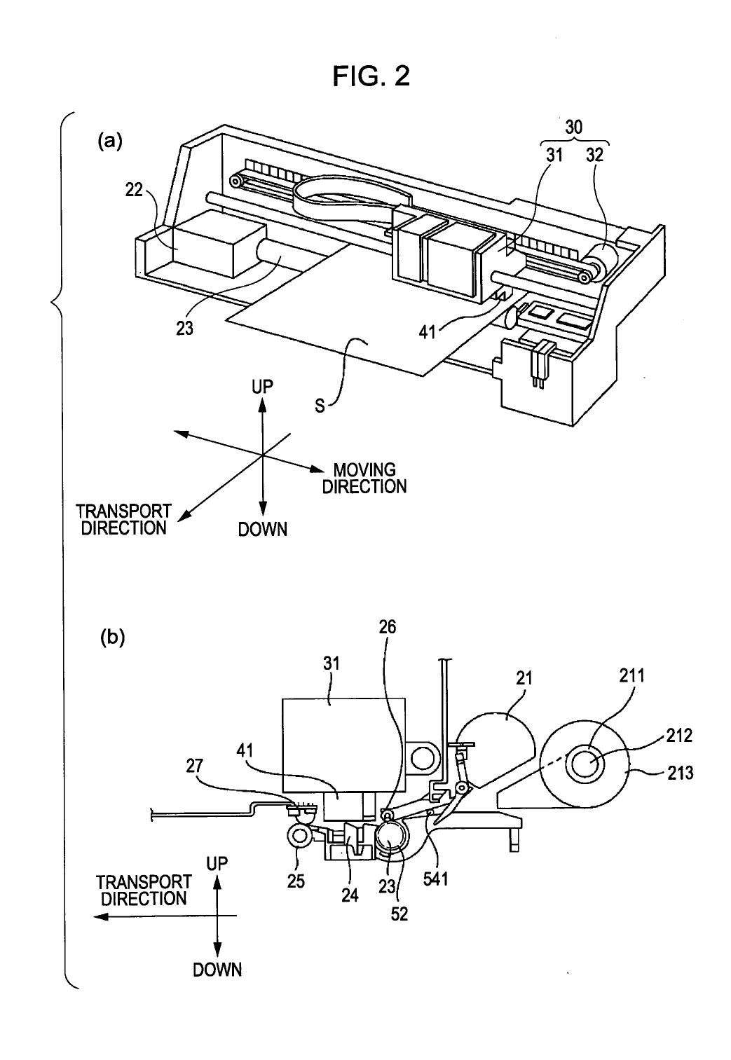

FIG. 1 is a block diagram of the entire configuration of a printer 1. In addition, FIG. 2A is a schematic view of the entire configuration of the printer 1. In addition, FIG. 2B is a transverse sectional view of the entire configuration of the printer 1. Hereinafter, the basic configuration of the printer will be described.

The printer 1 includes a transport unit 20, a carriage unit 30, a head unit 40, a detector group 50, and a controller 60. The printer 1 that has received print data from a computer 110, which is an external apparatus, controls each of the units (the transport unit 20, the carriage unit 30, and the head unit 40) by using the controller 60. The controller 60 controls each unit on the basis of the print data received from the computer 110 and prints an image on paper. The situation in the printer 1 is monitored by the detector group 50, and the detector group 50 outputs a detection result to the controller 60. The controller 60 controls each unit on the basis of the detection result output from the detector group 50.

The transport unit 20 serves to transport a printing medium (for example, paper S) in a predetermined direction (hereinafter, called a transport direction). The transport unit 20 has a paper feed roller 21, a transport motor 22 (also called a PF motor), a transport roller 23, a platen 24, and a paper discharge roller 25. The paper feed roller 21 is a roller for feeding the paper inserted in a paper insert hole into the printer. The transport roller 23 is a roller that is driven by the transport motor 22 and transports the paper S fed by the paper feed roller 21 up to a printable region together with a driven roller. The platen 24 supports the paper S being printed. The paper discharge roller 25 is a roller that discharges the paper S to the outside of the printer together with driven rollers 26 and 27 and is provided at a downstream side of the transport direction with respect to the printable region. The paper discharge roller 25 rotates in synchronization with the transport roller 23.

In the printer 1 in the present embodiment, the paper S is supplied from a roll paper 211. The roll paper 211 is provided on a cylindrical member 212 that is rotatably fixed to a roll paper supporting portion 213. Due to the inertia that the roll paper 211 and the cylindrical member 212 have and the frictional force of each portion being in contact with the roll paper 211, the paper S is pulled by the transport roller 23 to be transported inside the printer 1.

The carriage unit 30 serves to move (also called ‘scan’) a head in a predetermined direction (hereinafter, called a moving direction). The carriage unit 30 has a carriage 31 and a carriage motor 32 (also called a CR motor). The carriage 31 can reciprocate in the moving direction and is driven by the carriage motor 32.

The head unit 40 serves to discharge ink onto the paper. The head unit 40 includes a head 41 having a plurality of nozzles. Since the head 41 is provided on the carriage 31, the head 41 also moves in the moving direction when the carriage 31 moves in the moving direction. In addition, a dot line (raster line) along the moving direction is formed on the paper by discharging ink intermittently while the head 41 is moving in the moving direction.

An encoder 52 for a transport roller and an encoder 54 for direct detection are included in the detector group 50. The encoder 52 for a transport roller, which will be described later, is fixed to one end of a shaft of the transport roller 23 and detects the rotation amount of the transport roller 23. In addition, the encoder 54 for direct detection, which will be described later, is provided at a more upstream side than the transport roller 23 in the transport direction of the paper.

In the drawing, a driven rotation member 541 included in the encoder 54 for direct detection is shown. The driven rotation member 541 is in contact with an upper surface of the paper and is driven to rotate with transport of the paper S. The encoder 54 for direct detection detects the rotation amount of the driven rotation member 541. In addition, a linear encoder that detects the movement amount in the moving direction of the carriage 31, a paper detecting sensor that detects whether or not there is paper, and the like are included in the detector group 50.

The controller 60 is a control unit for controlling the printer 1. The controller 60 includes an interface portion (not shown), a CPU, and a memory. An interface portion performs transmission and reception of data between the printer 1 and the computer 110 that is an external apparatus. The CPU is a processing unit for making an overall control of the printer. The memory serves to secure a region for storing a program of the CPU, a working area, and the like and has memory devices, such as a RAM and an EEPROM. The CPU controls each unit according to the program stored in the memory.

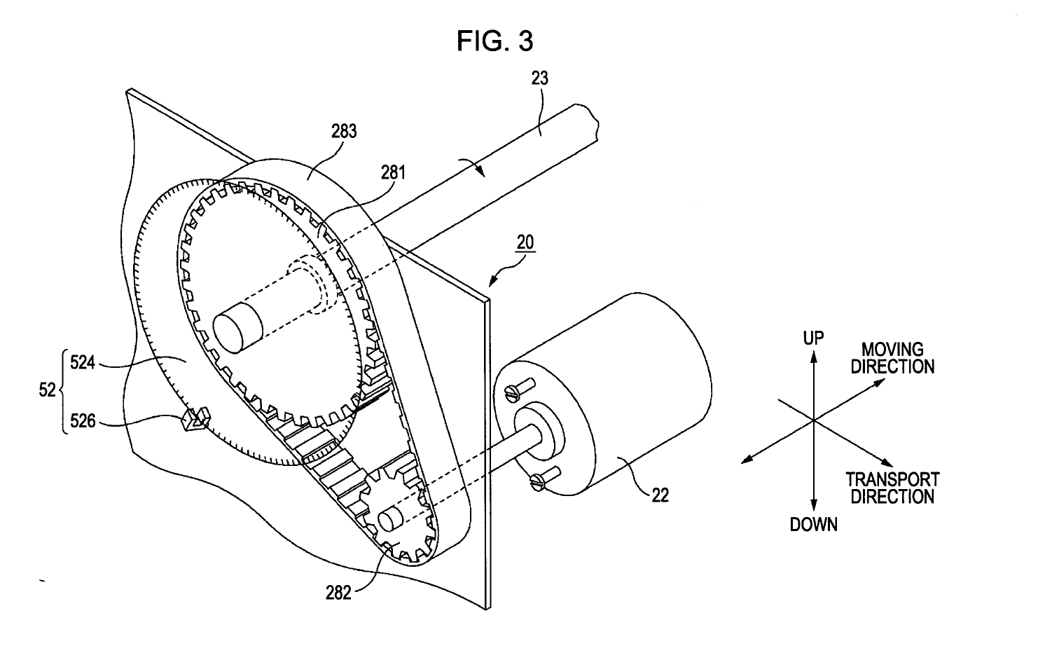

FIG. 3 is a view for explaining the encoder 52 for a transport roller. The transport motor 22 is shown in the drawing. A pinion 282 is integrally fixed to an output shaft of the transport motor 22. In addition, a main wheel 281 is shown in the drawing. In addition, a belt 283 is stretched over the main wheel 281 and the pinion 282, and the power is transmitted to the main wheel 281 when the output shaft of the transport motor 22 is made to rotate. The main wheel 281 is integrally fixed to one end of the transport roller 23. Accordingly, the transport roller 23 rotates with rotation of the main wheel 281. In addition, a first rotating circular plate 524 is integrally fixed to the shaft of the transport roller 23 so as to be adjacent to the main wheel 281. Small slits are formed at predetermined distances therebetween on the first rotating circular plate 524.

A first detection unit 526 of the encoder 52 for a transport roller is provided to interpose a portion of the slits of the first rotating circular plate 524. The rotation amount of the transport roller 23 can be calculated since the first detection unit 526 monitors the slits of the first rotating circular plate 524.

In addition, even though the pitch of the gear is largely shown in the drawing so as to be easily understood, a finer pitch may be set to improve a transport system.

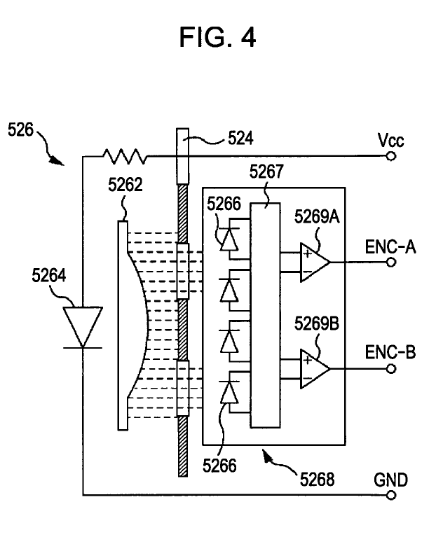

FIG. 4 is a view illustrating the configuration of the first detection unit 526 of the encoder 52 for a transport roller. The encoder 52 for a transport roller has the first rotating circular plate 524 and the first detection unit 526 as described above. The first detection unit 526 has a light-emitting diode 5264, a collimator lens 5262, and a detection processing portion 5268, and the detection processing portion 5268 includes a plurality of (for example, four) photodiodes 5266, a signal processing circuit 5267, and two comparators 5269A and 5269B.

The light-emitting diode 5264 emits light when a voltage Vcc is applied through a resistor of both ends, and the light is incident on the collimator lens 5262. The collimator lens 5262 makes light emitted from the light-emitting diode 5264 become parallel beams and irradiates the parallel beams onto the first rotating circular plate 524. The parallel beam that passed the slit provided on the first rotating circular plate 524 passes a fixed slit (not shown) to be incident on each photodiode 5266. The photodiode 5266 converts the incident light into an electrical signal. The electrical signals output from the respective photodiodes are compared in the comparators 5269A and 5269B, and the comparison result is output as a pulse. In addition, a first pulse ENC_A and a second pulse ENC_B output from the comparators 5269A and 5269B become outputs of the encoder 52 for a transport roller.

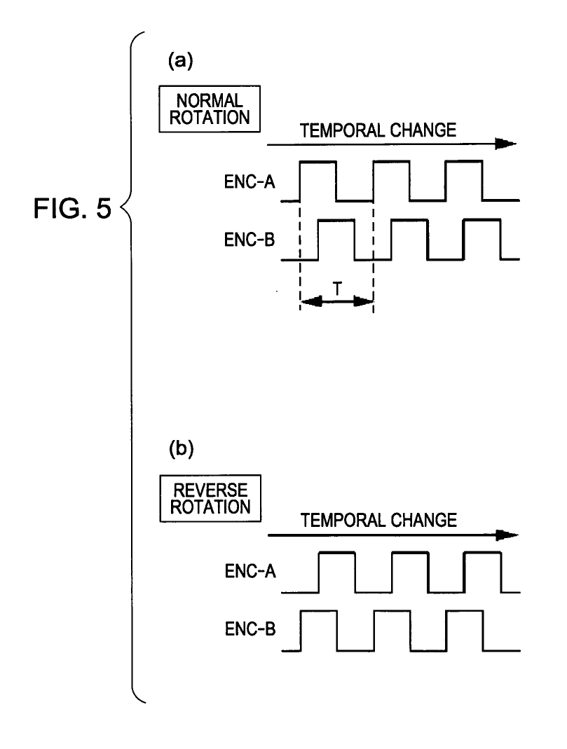

FIG. 5A is a timing chart showing output waveforms at the time of normal rotation of the encoder 52 for a transport roller, and FIG. 5B is a timing chart that supports output waveforms of the encoder at the time of reverse rotation of the encoder 52 for a transport roller. As shown in the drawing, in any case of the normal rotation and reverse rotation of the transport roller 23, the first pulse ENC_A and the second pulse ENC_B, the phase is shifted by 90°. While the transport roller 23 is performing normal rotation, the phase of the first pulse ENC_A leads that of the second pulse ENC_B by 90° as shown in FIG. 5A. On the other hand, while the transport roller 23 is performing reverse rotation, the phase of the first pulse ENC_A lags behind the second pulse ENC_B by 90° as shown in FIG. 5B. A period T of each pulse is equal to a time for which one distance of the slits of the first rotating circular plate 524 moves through the first detection unit 526.

In addition, the first pulse ENC_A and the second pulse ENC_B of the encoder 52 for a transport roller are input to the controller 60. The controller 60 can calculate the rotation speed and the rotation amount on the basis of the pulse distance that is input.

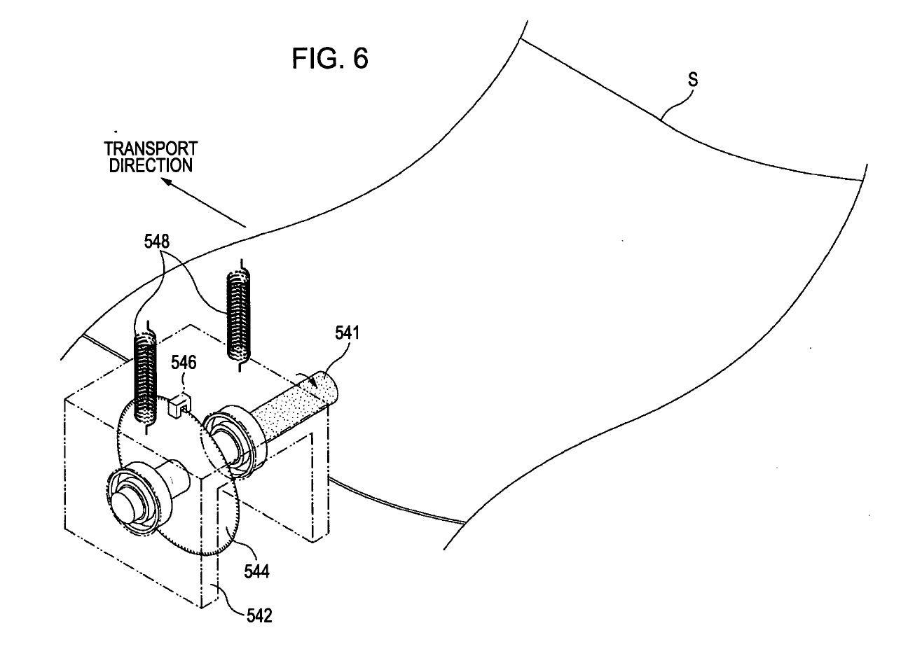

FIG. 6 is a view for explaining the encoder 54 for direct detection. In the drawing, the paper S and the driven rotation member 541 that is in direct contact with the upper surface of the paper S are shown. On a portion of the driven rotation member 541 being in contact with the paper S, surface treatment for increasing the coefficient of friction is performed to secure the frictional force with the paper.

Two bearings 545 for rotatably supporting the driven rotation member 541 are fixed to the driven rotation member 541. In addition, a second rotating circular plate 544 is disposed between the two bearings 545. The second rotating circular plate 544 is integrally fixed to the driven rotation member 541, and the second rotating circular plate 544 also rotates when the driven rotation member 541 rotates. Similar to the first rotating circular plate 524, slits are formed on the second rotating circular plate 544.

A second detection unit 546 of the encoder 54 for direct detection (referred to as a second detection unit) is provided to interpose the slits of the second rotating circular plate 544. The second detection unit 546 monitors the slits of the second rotating circular plate 544 and transmits a pulse to the controller 60. The controller 60 can calculate the rotation speed and the rotation amount on the basis of the pulse distance that is input. The rotation amount of the driven rotation member 541 can be calculated. Since the configuration of the second detection unit 546 is the same as the configuration of the first detection unit 526, an explanation thereof will be omitted.

The two bearings 545 and the second detection unit 546 are integrally supported by a support member 542. In addition, the support member 542 is fixed to the inside of the printer 1 through two springs 548. The support member 542 can move slidably only in the up and down direction of the printer 1 since the movable direction is limited by a member (not shown). The support member 542 is pressed in the lower direction of the printer 1 by the two springs 548. In addition, the driven rotation member 541 is necessarily in contact with the paper S by predetermined pressure. In this way, the driven rotation member 541 is driven to rotate with transport of the paper S.

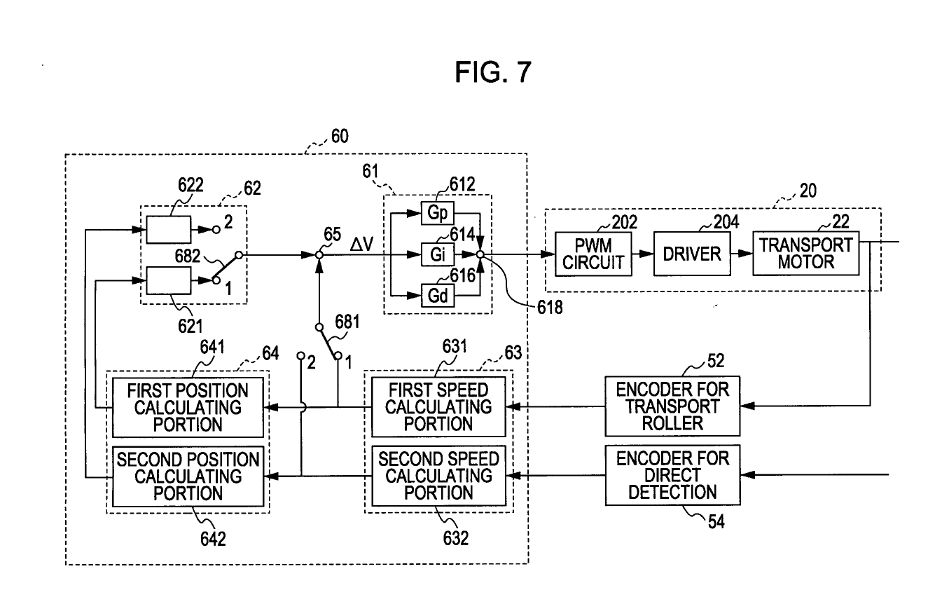

FIG. 7 is a block diagram for explaining the relationship of the controller 60, the transport unit 20, and each encoder in the first embodiment. The controller 60, the transport unit 20, the encoder 52 for a transport roller, and the encoder 54 for direct detection are shown in the drawing. The controller 60 includes a PID control element portion 61, a target speed output portion 62, a speed calculating portion 63, and a position calculating portion 64. In addition, the controller 60 includes a subtracter 65 and a first switch 681.

The speed calculating portion 63 includes a first speed calculating portion 631 and a second speed calculating portion 632. The first speed calculating portion 631 measures the period of an output pulse of the encoder 52 for a transport roller and calculates the rotation speed of the transport roller 23 on the basis of the period. In addition, a transport speed when ideal transport is performed by the transport roller 23 is calculated to be output on the basis of the rotation speed of the transport roller 23 and the external diameter of the transport roller 23.

In addition, the second speed calculating portion 632 measures the period of an output pulse of the encoder 54 for direct detection and calculates the rotation speed of the driven rotation member 541 on the basis of the period. In addition, the transport speed of the paper S detected by the driven rotation member 541 is calculated to be output on the basis of the rotation speed of the driven rotation member 541 and the external diameter of the driven rotation member 541.

The first switch 681 switches a connection with the subtracter 65, which will be described later, between the first speed calculating portion 631 and the second speed calculating portion 632. When the first switch 681 is connected to a connection end ‘1’, an output of the first speed calculating portion 631 is transmitted to the subtracter 65. In addition, when the first switch 681 is connected to a connection end ‘2’, an output of the second speed calculating portion 632 is transmitted to the subtracter 65.

The output of the first speed calculating portion 631 is connected to a first position calculating portion 641. In addition, the output of the second speed calculating portion 632 is connected to a second position calculating portion 642.

The position calculating portion 64 includes the first position calculating portion 641 and the second position calculating portion 642. The first position calculating portion 641 integrates the speed transmitted from the first speed calculating portion 631 and calculates the transport amount when ideal transport is performed by the transport roller 23. Then, the current position of the paper S is calculated from the transport amount and is output to a first target speed output portion 621. In addition, the second position calculating portion 642 integrates the speed transmitted from the second speed calculating portion 632 and calculates the transport amount of the paper S detected by the driven rotation member 541. Then, the current position of the paper S is calculated from the transport amount and is output to a second target speed output portion 622.

The target speed output portion 62 includes the first target speed output portion 621, the second target speed output portion 622, and a second switch 682. An output (position of the paper S calculated on the basis of the output of the encoder 52 for a transport roller) of the first position calculating portion 641 is input to the first target speed output portion 621. The first target speed output portion 621 has a first speed profile which will be described later. In addition, the first target speed output portion 621 can output the target transport speed on the basis of a distance from the current position of the paper S, which was calculated on the basis of the output of the encoder 52 for a transport roller, to the target transport position.

In addition, an output (position of the paper S calculated on the basis of the output of the encoder 54 for direct detection) of the second position calculating portion 642 is input to the second target speed output portion 622. The second target speed output portion 622 has a second speed profile which will be described later. In addition, the second target speed output portion 622 can output the target transport speed on the basis of a distance from the current position of the paper S, which was calculated on the basis of the output of the encoder 54 for direct detection, to the target transport position.

The second switch 682 operates in conjunction with the first switch 681, and the second switch 682 is connected to the connection end ‘1’ when the first switch 681 is connected to the connection end ‘1’. In addition, when the first switch 681 is connected to the connection end ‘2’, the second switch 682 is also connected to the connection end ‘2’. In addition, the other end of the second switch is connected to the subtracter 65. In addition, the target transport speed output from the first target speed output portion 621 or the second target speed output portion 622 is transmitted to the subtracter 65.

The subtracter 65 subtracts the transport speed, which is output from the first speed calculating portion 631 or the second speed calculating portion 632, from the target transport speed output from the target speed output portion 62 and outputs the deviation, which is a subtraction result, to the PID control element portion 61.

The PID control element portion 61 includes a proportional element 612, an integral element 614, and a differential element 616. In addition, the PID control element portion 61 includes an adder 618. The proportional element 612 multiplies a speed error ΔV by a gain Gp and outputs a proportional component QP. The integral element 614 integrates that obtained by multiplying the speed error ΔV by the gain Gi to a calculation result QI(j−1) before one and outputs an integral component QI. The differential element 616 multiplies a difference between a current speed error ΔV(j) (here, j indicates time) and a speed error ΔV(j−1) before one by a gain Gd and outputs a differential component QD.

Here, the calculation outputs of the proportional element 612, the integral element 614, and the differential element 616, that is, the proportional component QP, the integral component QI, and the differential component QD can be given by the following expressions (1) to (3).

QP(j)=ΔV(j)×Gp (1)

QI(j)=QI(j−1)+ΔV(j)×Gi (2)

QD(j)={ΔV(j)−ΔV(j−1)}×Gd (3)

The adder 618 adds the proportional component QP of the proportional element 612, the integral component QI of the integral element 614, and the differential component QD of the differential element 616. An addition result ΣQ of the three components, that is, the proportional component QP, the integral component QI, and the differential component QD is output as a duty signal to a PWM circuit 202, which will be described later.

The addition result ΣQ can be obtained by the following expression (4).

ΣQ(j)=QP(j)+QI(j)+QD(j) (4)

The PWM circuit 202, a driver 204, and the transport motor 22 are included in the transport unit 20. The PWM circuit 202 generates a control signal corresponding to the addition result ΣQ of the adder 618. The driver 204 drives the transport motor 22 on the basis of the control signal. The driver 204 has a plurality of transistors, for example, and applies a voltage to the transport motor 22 by turning on and off the transistors on the basis of the control signal from the PWM circuit 202.

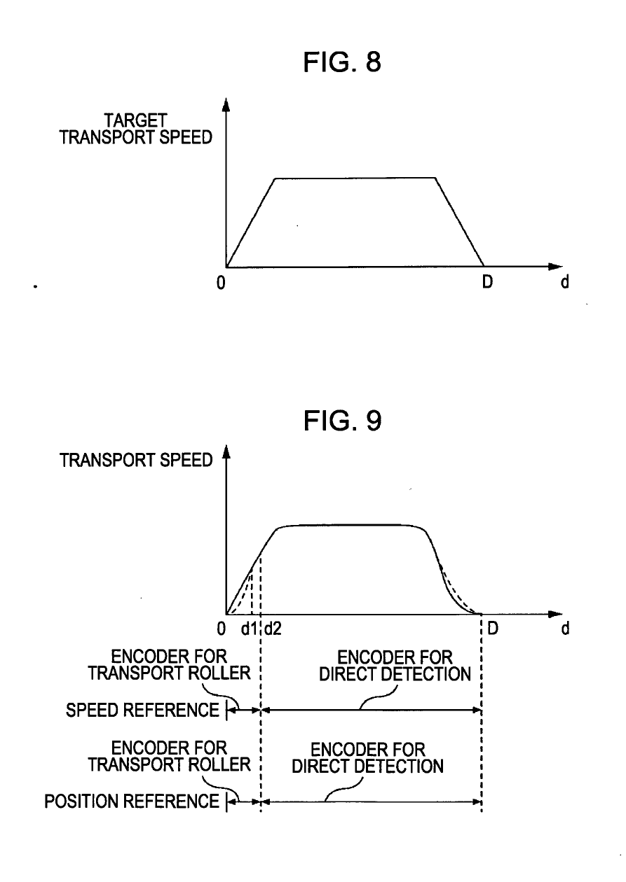

FIG. 8 is a view for explaining the speed profile. In the speed profile, a suitable target speed at the current position of the paper S is calculated beforehand when transporting the paper S up to a target transport position D.

A graph of the speed profile in which the horizontal axis indicates a distance and a vertical axis indicates a target transport speed is shown in the drawing. In the drawing, the position of ‘D’ is assumed to be the target transport position. In addition, a target transport speed corresponding to the current position in the range from a position 0 to the target transport position D is expressed in the vertical axis.

A first speed profile for calculating the target transport speed from the position of the paper S calculated on the basis of the output of the encoder 52 for a transport roller and a second speed profile for calculating the target transport speed from the position of the paper S calculated on the basis of the output of the encoder 54 for direct detection are prepared for the speed profile. The first speed profile is stored in the first target speed output portion 621, and the second speed profile is stored in the second target speed output portion 622.

When the first switch 681 and the second switch 682 are connected to the connection end ‘1’, the first position calculating portion 641 calculates the target transport speed corresponding to the current position of the paper S calculated on the basis of the output of the encoder 52 for a transport roller referring to the first speed profile and outputs the target transport speed. Similarly, when the first switch 681 and the second switch 682 are connected to the connection end ‘2’, the second position calculating portion 642 calculates the target transport speed corresponding to the current position of the paper S calculated on the basis of the output of the encoder 54 for direct detection referring to the second speed profile and outputs the target transport speed.

In addition, here, although the explanation has been made assuming that the first speed profile and the second speed profile are different, one speed profile may be used in common.

FIG. 9 is a view for explaining speed reference and position reference. A graph of a transport speed with respect to a position d(d1, d2) is shown in the drawing. In this graph, a portion drawn by a solid line is a transport speed that the first speed calculating portion 631 outputs on the basis of the output of the encoder 52 for a transport roller.

Moreover, in this graph, a portion drawn by a broken line is a transport speed that the second speed calculating portion 632 outputs on the basis of the output of the encoder 54 for direct detection. In addition, since there is a portion where the speed that the second speed calculating portion 632 outputs matches the speed that the first speed calculating portion 631 outputs, solid lines overlap at this time.

In addition, the ‘speed reference’ of whether to make a control on the basis of the transport speed, which was calculated on the basis of the output of either encoder at the position of the paper S, is shown below the graph. In addition, the ‘position reference’ of whether to output the target transport speed on the basis of the position, which was calculated on the basis of the output of either encoder at the position of the paper S, is shown below the graph.

Referring to the graph of the speed immediately after start of the movement, the transport speed that the first speed calculating portion 631 outputs rises almost linearly, while the transport speed that the second speed calculating portion 632 outputs rises with some delay. This is thought that actual transport of the paper S was delayed due to slip occurring between the transport roller 23 and the paper S even though the transport of the paper S was started by the transport roller 23. Furthermore, it may also be considered that the movement of the paper S at the position of the driven rotation member 541 was delayed since the paper S deformed due to a force in the transport direction momentarily applied to the paper S even though the transport of the paper S was started by the transport roller 23.

However, at the position d1 after start of rotation of the transport roller 23, the speed that the first speed calculating portion 631 outputs almost matches the speed of the second speed calculating portion 632. In addition, the actual position d1 is a position which is very close to the position ‘0’. Here, in order to show the situation where detection of transport performed by the encoder 54 for direct detection is delayed, the delay is shown with some emphasis.

In the present embodiment, information on the transport speed to be referred is changed with a position d2 after the movement up to the position d1 as a reference. In addition, information on the position to be referred is changed with the position d2 as a reference. First, until the movement range of the paper S calculated from the output of the encoder 52 for a transport roller reaches the position d2 from ‘0’, a control to the target transport speed is performed on the basis of the output from the first speed calculating portion 631. In addition, until the movement range of the paper S calculated from the output of the encoder 52 for a transport roller reaches the position d2 from ‘0’, output of the target transport speed is performed on the basis of the output from the first position calculating portion 641.

It is determined whether or not the position of the paper has reached the position d2 on the basis of the output of the second position calculating portion 642. That is, the determination is performed on the basis of the position that was calculated on the basis of the output of the encoder 54 for direct detection. This is because it is thought that the second position calculating portion 642 calculates the position of the paper S more precisely than the first position calculating portion 641 since the encoder 54 for direct detection detects the transport amount of the paper S directly.

When the position d2 of the paper is exceeded, the connection between the first switch 681 and the second switch 682 changes from the connection end ‘1’ to the connection end ‘2’. Then, transport from the position d2 to the target transport position D is performed. At this time, a control of the transport speed is performed on the basis of the output of the second speed calculating portion 632. That is, the control of the transport motor 22 is performed on the basis of the output of the encoder 54 for direct detection. Moreover, at this time, output of the target transport speed is performed on the basis of the output of the second position calculating portion 642. That is, the output of the target transport speed is performed on the basis of the position based on the output of the encoder 54 for direct detection.

In addition, it is assumed that a suitable position calculated beforehand by an experiment is used as the position d2 as the trigger of switching of the first switch 681 and the second switch 682.

In this way, a control of the transport motor 22 is performed (corresponding to a first control mode) on the basis of the output of the encoder 52 for a transport roller when the paper S is in a stop state, and a control (corresponding to a second control mode) using the encoder 54 for direct detection is performed while the paper S is moving surely (after the paper S starts moving surely). In this way, also in the case where the movement of the paper S is not detected by the encoder 54 for direct detection even though the transport roller 23 rotates immediately after start of transport of the paper S, the transport motor 22 can be controlled without feeding back the speed based on the output from the encoder 54 for direct detection. In addition, a control immediately after the start of transport of the paper S can be performed stably.

In addition, although the determination on whether or not the position of the paper S exceeds the position d2 was performed on the basis of the position of the paper S calculated on the basis of the output of the encoder 54 for direct detection, the determination may also be made on the basis of the position of the paper S calculated on the basis of the output of the encoder 52 for a transport roller.

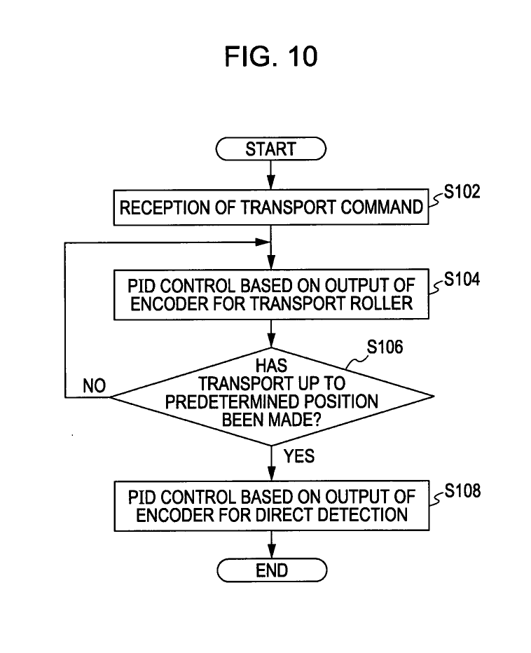

FIG. 10 is a flow chart of the transport control in the first embodiment. Hereinafter, transport of the paper S to the target transport position will be described according to the flow chart. In the printer 1, printing is performed while the paper S is being transported intermittently. For example, a transport control according to the flow chart is performed for each of such intermittent movement of the paper S.

A transport command including information on the target transport position is generated for every transport operation of the paper. When the transport command is received (step S102), the controller 60 starts transport by the PID control to the target transport position on the basis of the output of the encoder 52 for a transport roller. The PID control based on the output of this encoder 52 for a transport roller is performed in transport to a predetermined position (position d2 calculated on the basis of the output of the encoder 54 for direct detection).

The controller 60 determines whether or not the transport to the predetermined position was performed (step S106). This determination may be performed for every rising and falling of the edge that is the output of the encoder 52 for a transport roller. Here, when the transport to the predetermined position d2 is not performed, the PID control based on the output of the encoder 52 for a transport roller is performed subsequently (step S104). On the other hand, when the transport to the predetermined position is completed, the PID control based on the output of the encoder 54 for direct detection is started (step S108). Then, up to the target transport position D, a control of the transport motor 22 that performed the PID control on the basis of the output of the encoder 54 for direct detection is performed. When movement to the target transport position D is completed, the transport operation ends.

In the first embodiment described above, the first control mode and the second control mode were switched according to switching of the first switch 681 and the second switch 682 based on the determination on whether or not the position of the paper S exceeded the position d2. However, the first control mode and the second control mode may also be switched on the basis of whether or not the second detection unit 546 can detect rotation of the driven rotation member 541 as the second rotating circular plate. That is, when the position of the paper S does not exceed the position d2, the transport motor 22 is controlled in the first control mode. When the second detection unit 546 can detect the rotation of the driven rotation member 541 and the position of the paper S exceeds the position d2, the transport motor 22 is controlled in the second control mode. When the second detection unit 546 cannot detect the rotation of the driven rotation member 541, the transport motor 22 is controlled only in the first control mode without switching the first control mode and the second control mode.

In this way, also in the case where the movement of the paper S is not detected by the second detection unit 546 even though the transport roller 23 rotates to transport the paper S, the control of the transport motor 22 based on the output of the first detection unit 526 can be performed.

As the case where the movement of the paper S is not detected by the second detection unit 546 even though the transport roller 23 rotates to transport the paper S, for example, a case where the second detection unit 546 or the encoder 54 for direct detection is poor or a case where the paper S is cut paper may be considered. In the case where the paper S is cut paper, since the length of the paper S in the paper transport direction may be shorter than the length between the transport roller 23 and the driven rotation member 541, a case where the movement of the paper S is not detected by the second detection unit 546 even though the paper S is transported may occur.

### Second Embodiment

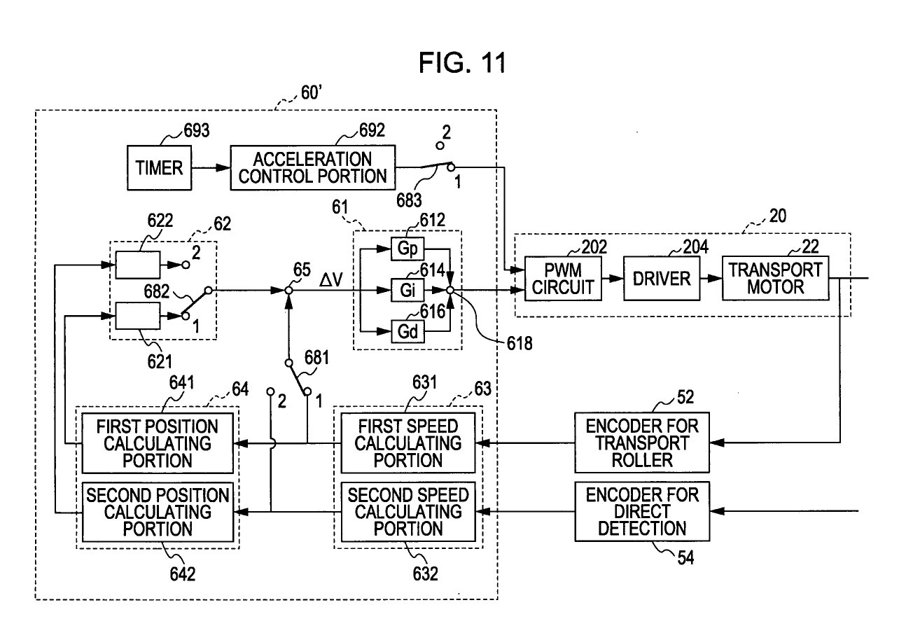

FIG. 11 is a view for explaining a controller 60′ in a second embodiment. In the second embodiment, a timer 693, an acceleration control portion 692, and a third switch 683 are included in the controller 60′ in addition to each portion within the controller 60 in the first embodiment. Accordingly, the same reference numeral is given to each portion included in the controller 60 in the first embodiment and an explanation thereof will be omitted.

An output of the timer 693 is connected to the acceleration control portion 692. An output of the acceleration control portion 692 is connected to the third switch 683. In addition, the other end of the third switch 683 is connected to the PWM circuit 202. In addition, the acceleration control portion 692 and the timer 693 are used at the time of acceleration control of the transport motor 22. The timer 693 generates a timer interruption signal for every predetermined time on the basis of a clock signal generated in the controller 60′. The acceleration control portion 692 integrates a predetermined duty DXP whenever the timer interruption signal is received, generates a duty signal as the integration result, and outputs the duty signal to the PWM circuit 202.

The third switch 683 operates in conjunction with the above-described first and second switches 681 and 682. For example, when the first switch 681 is connected to the connection end ‘1’, the third switch 683 is also connected to the connection end ‘1’. Moreover, when the first switch 681 is connected to the connection end ‘2’, the connection with the connection end ‘1’ is cut so that the third switch 683 also becomes a position of the connection end ‘2’.

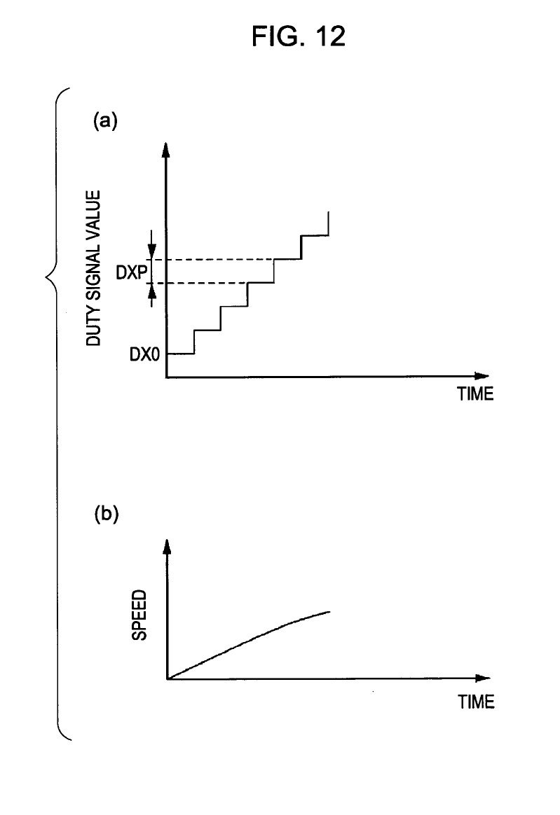

FIG. 12A is a graph of a temporal change of a duty signal, and FIG. 12B is a graph of a speed change of a transport motor. When the transport motor 22 is started while the transport motor 22 stops, an initial duty signal whose signal value is a signal value DX0 is transmitted from the acceleration control portion 692 to the PWM circuit 202. This initial duty signal is generated in the acceleration control portion 692 together with a start command signal. Then, the initial duty signal is converted into a control signal corresponding to the signal value DX0 by the PWM circuit 202, such that the transport motor 22 starts to operate.

After the controller 60′ generates a start command signal, a timer interruption signal is generated from the timer 693 for every predetermined time. Whenever the timer interruption signal is received, the acceleration control portion 692 integrates the signal value DX0 of the initial duty signal with the predetermined duty DXP and transmits to the PWM circuit 202 a duty signal having the integrated duty as a signal value. This duty signal is converted into a control signal corresponding to the signal value by the PWM circuit 202, and the rotation speed of the transport motor 22 increases. For this reason, the value of the duty signal transmitted from the acceleration control portion 692 to the PWM circuit 202 rises in a stepwise manner.

The second position calculating portion 642 calculates the transport amount of the paper S on the basis of the output of the encoder 54 for direct detection. Then, the current position of the paper S is calculated from the transport amount and is outputs to the second target speed output portion 622. In addition, when the position of the paper S calculated on the basis of the output of the encoder 54 for direct detection exceeds the position d2, the connection of the first to third switches 681 to 683 is switched from the connection end ‘1’ to the connection end ‘2’. A control after the connection of the first to third switches 681 to 683 was switched to the connection end ‘2’ is the same as the control after the connection of the first and second switches 681 and 682 was switched to the connection end ‘2’ in the first embodiment described above and accordingly, the explanation will be omitted.

In addition, although the determination on whether or not the position of the paper S exceeds the position d2 was also performed herein on the basis of the position of the paper S calculated on the basis of the output of the encoder 54 for direct detection, the determination may also be performed on the basis of the position of the paper S calculated on the basis of the output of the encoder 52 for a transport roller.

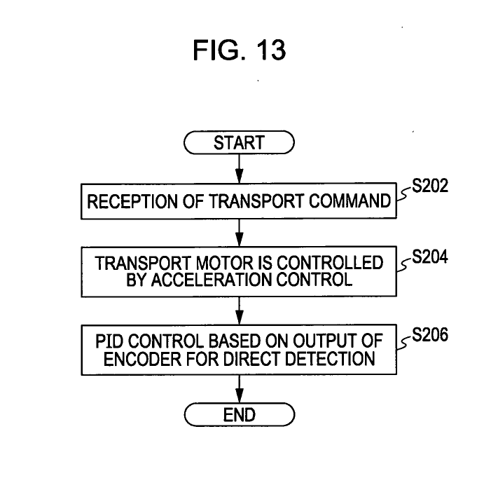

FIG. 13 is a flow chart of the transport control in the second embodiment. Hereinafter, transport of the paper S to the target transport position will be described according to the flow chart.

A transport command including information on the target transport position is transmitted for every transport operation of the paper. When the transport command is received (step S202), the controller 60′ performs an acceleration control using the acceleration control portion 692 and the timer 693 described above. Then, the rotation speed of the transport motor 22 increases. Accordingly, movement of the paper S is started.

The controller 60′ determines whether or not transport to the predetermined position d2 was performed on the basis of the position of the paper S that was calculated on the basis of the output of the encoder 54 for direct detection (step S206). This determination may be performed for every rising and falling of the edge that is the output of the encoder 52 for a transport roller. Here, when the transport to the predetermined position d2 is not performed, an acceleration control is performed subsequently (step S204). On the other hand, when the transport to the predetermined position d2 is completed, the PID control based on the output of the encoder 54 for direct detection is started (step S208). Then, up to the target transport position D, a control of the transport motor 22 that performed the PID control on the basis of the output of the encoder 54 for direct detection is performed. When movement to the target transport position D is completed, the transport operation ends.

In this way, a control of the transport motor 22 is performed (corresponding to a first control mode) by the acceleration control when the paper S is in a stop state, and a control (corresponding to a second control mode) using the encoder 54 for direct detection is performed while the paper S is moving surely (after the paper S starts moving surely). In this way, also in the case where the movement of the paper S is not detected by the encoder 54 for direct detection even though the transport roller 23 rotates immediately after start of transport of the paper S, the transport motor 22 can be controlled without feeding back the speed based on the output from the encoder 54 for direct detection. In addition, a control immediately after the start of transport of the paper S can be performed stably.

### Control of the Position of the Paper S

In the above-described embodiment, the transport amount of the paper S can be precisely grasped by providing the encoder 54 for direct detection. Therefore, the position of the paper S in a range where the paper S is in contact with the driven rotation member 541 of the encoder 54 for direct detection can be precisely controlled on the basis of the position calculated by using the output of the encoder 54 for direct detection.

When feed of a sheet of paper S is performed by a plural number of transports, the target stop position can be corrected, for example, by adding a stop error occurred in transport in this path to transport in the next path. Then, the transport of the paper can be performed by removing the stop error that occurred in the next transport. Also in this case, the position control of the paper S with respect to the printer 1 can be performed more precisely by acquiring the position of the paper S while using the output of the encoder 54 for direct detection consistently.

In addition, in case of controlling the position of the paper S without using a result of the output of the encoder 54 for direct detection, the absolute position of the paper S can be controlled by using a result of the output of the encoder 52 for a transport roller consistently.

### Other Embodiments

Although the printer 1 is described as a liquid discharging apparatus in the above-described embodiment, embodiment as a liquid discharging apparatus that ejects or discharges other fluids (liquid, a liquid-like body in which particles of a functional material are dispersed, or a fluid-like body such as gel) other than ink may also be made without being limited to the printer. For example, the same technique as the above-described embodiment may also be applied to various apparatuses applying the ink jet technique, such as a color filter manufacturing apparatus, a dyeing apparatus, a micro-machining apparatus, a semiconductor manufacturing apparatus, a surface treatment apparatus, a three-dimensional modeling device, a gas vaporizer, an organic EL manufacturing apparatus (particularly a polymer EL manufacturing apparatus), a display manufacturing apparatus, a film forming apparatus, and a DNA chip manufacturing apparatus. Moreover, these methods or manufacturing methods are also in the category of an application range.

The above embodiments are to make the present invention easily understood and are not interpreted to limit the present invention. The present invention may be changed and modified without departing from the object, and it is needless to say that the equivalents are included in the present invention. Particularly embodiments described below are also included in the present invention.

### Regarding a Head

In the above-described embodiment, ink was discharged by using a piezoelectric element. However, a method of discharging the liquid is not limited thereto. Other methods, for example, a method of generating bubbles within a nozzle with heat may also be used.

Moreover, in the above-described embodiment, the head was provided on the carriage. However, the head may also be provided on an ink cartridge which can be attached to or detached from the carriage.

1. An apparatus for carrying a printing medium comprising:
(A) a transport roller that transports the printing medium,
(B) a motor for rotating the transport roller,
(C) a detector that detects a transport amount of the printing medium transported by rotation of the transport roller, and
(D) a controller that has a first control mode, in which a control of the motor is not performed on the basis of a detection result of the detector, and a second control mode, in which a control of the motor is performed on the basis of the detection result of the detector, and that uses the first control mode in a state where the printing medium stops and uses the second control mode after the printing medium starts to moves.

2. The apparatus for carrying a printing medium according to claim 1, further comprising:
a first encoder for detecting a rotation amount of the transport roller,
wherein the controller controls the motor on the basis of a detection result of the first encoder in the first control mode.

3. The apparatus for carrying a printing medium according to claim 2,
wherein the controller controls the motor in the second control mode after the transport amount of the printing medium is calculated on the basis of the detection result of the detector and the transport amount exceeds a predetermined amount.

4. The apparatus for carrying a printing medium according to claim 3,
wherein in the first control mode, the controller controls the motor by increasing the electric power, which is supplied to the motor, by a predetermined amount for every predetermined time.

5. The apparatus for carrying a printing medium according to claim 4,
wherein the detector is a second encoder that detects a rotation amount of a roller that is driven to rotate with transport of the printing medium.

6. A printer comprising the apparatus for carrying a printing medium according to claim 5.

7. A method for carrying a printing medium comprising:
a step of controlling a motor, which rotates a transport roller that transports the printing medium, on the basis of a rotation amount of the transport roller, until the rotation amount of the transport roller reaches a predetermined amount from a state where the printing medium stops; and
a step of controlling the motor on the basis of a rotation amount of a roller, which is driven to rotate with transport of the printing medium, after the rotation amount of the transport roller exceeds the predetermined amount.

8. A recording medium recorded with a computer program for operating an apparatus for carrying a printing medium, the computer program causing the apparatus for carrying a printing medium to perform:
a step of controlling a motor, which rotates a transport roller that transports the printing medium, on the basis of a rotation amount of the transport roller, until the rotation amount of the transport roller reaches a predetermined amount from a state where the printing medium stops; and
a step of controlling the motor on the basis of a rotation amount of a roller, which is driven to rotate with transport of the printing medium, after the rotation amount of the transport roller exceeds the predetermined amount.

9. A printer comprising:
(A) a motor that rotates a first roller that transports a printing medium,
(B) a first detection unit that detects a rotation amount of a first rotating circular plate that rotates with rotation of the first roller,
(C) a second roller that rotates with transport of the printing medium,
(D) a second detection unit that detects a rotation amount of a second rotating circular plate that rotates with rotation of the second roller, and
(E) a controller that controls the motor,
wherein the controller controls the motor using a first control mode, in which a control of the motor is performed on the basis of a detection result of the first detection unit, and a second control mode, in which a control of the motor is performed on the basis of a detection result of the second detection unit.

10. The printer according to claim 9,
wherein the controller controls the motor in the second control mode when the rotation amount of the second rotating circular plate detected by the second detection unit exceeds a predetermined amount after controlling the motor in the first control mode.

11. The printer according to claim 10,
wherein the controller controls the motor only in the first control mode when the second detection unit does not detect the rotation amount of the second rotating circular plate.

12. The printer according to claim 11,
wherein the controller includes:
a speed calculating portion having a first speed calculating portion that calculates a rotation speed of the first roller on the basis of an output of the first detection unit and a second speed calculating portion that calculates a rotation speed of the second roller on the basis of an output of the second detection unit;
a position calculating portion having a first position calculating portion that calculates a position of the printing medium on the basis of an output of the first speed calculating portion and a second position calculating portion that calculates a position of the printing medium on the basis of an output of the second speed calculating portion;
a target speed output portion having a first target speed output portion, which outputs a target transport speed of the printing medium on the basis of an output from the first position calculating portion and a first speed profile determined beforehand, and second target speed output portion, which outputs a target transport speed of the printing medium on the basis of an output from the second position calculating portion and a second speed profile determined beforehand;
a subtracter that calculates a deviation between a transport speed and a target speed of the printing medium on the basis of an output of the speed calculating portion and an output of the target speed output portion;
a first switch that switches a connection to the subtracter between the first speed calculating portion and the second calculating portion; and
a second switch that switches a connection to the subtracter between the first target speed output portion and the second target speed output portion,
wherein the first and second switches operate in conjunction with each other, and
the controller controls the motor according to an output of the subtracter.
